(19) United States
(12) Patent Application Publication
(10) Pub. No.: US 2003/0221410 A1
(43) Pub. Date: Dec. 4, 2003

(54) Steam turbine

(76) Inventor: Thorsten Wolf, Nuremburg (DE)

Correspondence Address: STAAS & HALSEY LLP, SUITE 700, 1201 NEW YORK AVENUE, N.W., WASHINGTON, DC, 20005, US

(21) Appl. No.: 10/443,130

(22) Filed: May 22, 2003

(30) Foreign Application Priority Data
May 22, 2002 (EP) 02011282.7

(51) Int. Cl. F02C 6/18

(52) U.S. Cl. 60/39.182

(57) ABSTRACT

A steam-heated intermediate superheater is connected into a steam duct between a medium-pressure stage and a low-pressure stage of the steam turbine. The heating steam for the intermediate superheater may be extracted from the first intermediate superheater to increase efficiency of the steam turbine.

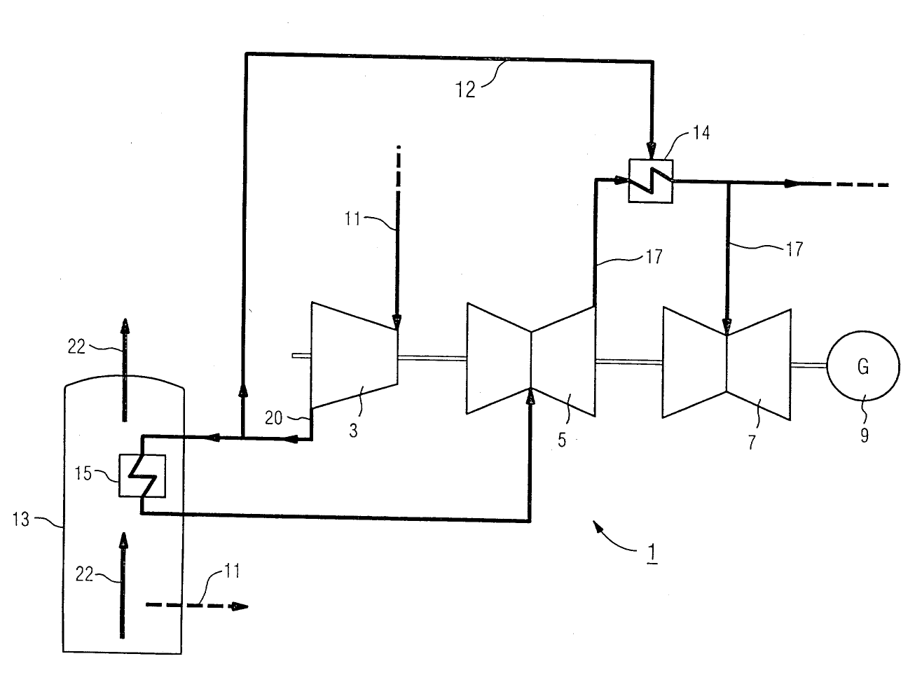

### CROSS REFERENCE TO RELATED APPLICATIONS

This application is based on and hereby claims priority to European Patent Application No. 02011282.7 filed on May 22, 2002, the contents of which are hereby incorporated by reference.

### BACKGROUND OF THE INVENTION

1. Field of the Invention

The invention relates to a steam turbine with at least one high-pressure stage, at least one medium-pressure stage and at least one low-pressure stage.

2. Description of the Related Art

Known steam power stations have, as a rule, a plurality of steam turbines, to which high-temperature operating steam is supplied from a steam boiler. The energy contained in this operating steam is converted by the steam turbine into rotational energy which, in turn, is converted into electrical energy by at least one generator connected to the steam turbine or steam turbines.

So that the energy contained in the operating steam can be utilized as effectively as possible, known steam turbines often have a plurality of turbine stages, for example a high-pressure, a medium-pressure and a low-pressure stage. In steam turbines of this kind, the residual energy located in the steam, after the latter leaves one turbine stage, is utilized in the following turbine stage, so that the steam turbine has as high an efficiency as possible.

The efficiency of steam power stations is determined mainly by the pressure and temperature of the steam flowing into the turbine stages and by the number of intermediate superheating stages and their respective superheating temperature.

The intermediate superheating stages of known steam power plants are typically arranged in the steam boiler, so that the entire steam which emerges from one turbine stage is superheated in the steam boiler and is supplied to the following turbine stage.

To increase flexibility, particularly with regard to the behavior of steam turbines, in the event of a load jump, the fresh-steam valves of known steam turbines are often throttled, so that, if required, these valves can be opened further or completely within a short time, with the result that a rapid turbine actuation reserve is implemented, particularly in order to stabilize power surges, which are manifested, for example, in a (sudden) deviation of the current mains frequency from a desired mains frequency.

### SUMMARY OF THE INVENTION

An object on which the invention is based is to improve known steam turbines, particularly with regard to the efficiency to be achieved and, furthermore, with regard to an improved useful life of the moving blades of the steam turbine, in particular of the moving blades of the low-pressure part.

This object is achieved, according to the invention, by a steam turbine with at least one high-pressure, at least one medium-pressure and at least one low-pressure stage, and with at least one steam duct which is arranged between the medium-pressure and the low-pressure stage, so that steam can be supplied from the medium-pressure to the low-pressure stage, the steam duct having connected into it at least one intermediate superheater which can be heated by steam.

Single and multiple intermediate superheating are known, in which the entire steam, after emerging from the high-pressure stage, is superheated in the steam boiler by an intermediate superheating stage. Intermediate superheating stages of this kind are consequently not heated with steam, but with hot gas which is carried in the steam boiler. The steam intermediately superheated in this way is then delivered to the medium-pressure part of the turbine.

Furthermore, in known steam turbines of this type, it is customary for the steam leaving the medium-pressure stage to be carried in an overflow line and to be supplied to the low-pressure part.

According to the invention a steam-heated intermediate superheater is connected into the steam duct between the medium-pressure part and the low-pressure part.

The steam duct may be designed, for example, as an overflow line (crossover) pipe) or as a flow duct within the turbine casing (for example an annular duct).

Since, according to the invention, the intermediate superheater cannot be heated by hot gas from the steam boiler, but by steam, this intermediate superheater is preferably not arranged in the steam boiler, but directly at or near to the steam turbine (for example in the turbine casing, in which case the steam duct may be an annular duct), so that the routing of steam to the intermediate superheater according to the invention, both in terms of the steam to be heated by the intermediate superheater and in terms of its heating steam, is simplified according to the invention.

By a steam-heated intermediate superheater of this type, connected into the steam duct between the medium-pressure and the low-pressure stage, therefore, further intermediate superheating is achieved with the result that the efficiency of the steam turbine is improved.

In one embodiment, the existing guide vanes in the steam turbine may be utilized as the intermediate superheater according to the invention.

The cause of the improvement is, inter alia, that the energy conversion process of the steam turbine is brought nearer to the ideal Carnot cycle by the steam-heated intermediate superheater according to the invention. Moreover, the steam wetness of the steam is reduced by a steam-heated intermediate superheater according to the invention.

Furthermore, flexibility in the operation of the steam turbine according to the invention is increased, since, for example, a relatively rapidly attainable rise in power output of the steam turbine can be achieved by a cutoff of the supply of steam to the steam-heated intermediate superheater. Furthermore, as a result of the abovementioned reduced steam wetness in the steam, which is supplied to the low-pressure stage, the useful life of the turbine blades of the low-pressure stage is increased.

Advantageously, the steam used to heat the intermediate superheater can be extracted from a steam stream which is supplied to a further intermediate superheater.

A further intermediate superheater of this type may be arranged, for example, in a steam boiler. In this embodiment, there is provision for extracting the heating steam for the steam-heated intermediate superheater from the steam stream which is supplied to the further intermediate superheater for intermediate superheating.

In known steam power plants, a plurality of intermediate superheaters are often found, which operate at a different temperature level in each case, so that it is easily possible to select from these a suitable intermediate superheater, of which the steam supplied to it has a suitable temperature for the purpose of use as heating steam according to the invention.

The further intermediate superheater may be, for example, that intermediate superheater by which the known first intermediate superheating, as it may be referred to, is implemented. The steam which is supplied to a further intermediate superheater of this type is particularly suitable for use as heating steam in connection with the invention, so that, advantageously, a steam stream is extracted from this steam and is supplied as heating steam to the steam-heated intermediate superheater. The condensate occurring during the steam-heated intermediate superheating according to the invention is advantageously supplied to an existing steam-side secondary condensate feed of a preheater of a turbine stage.

In a further advantageous embodiment of the invention, by a further intermediate superheater, steam can be heated which leaves the high-pressure stage and can be delivered to the medium-pressure stage.

In this embodiment of the invention, the further intermediate superheater is that intermediate superheater which intermediately superheats the steam from the high-pressure stage and delivers it to the medium-pressure stage. The steam which is delivered to a further intermediate superheater of this type has particularly favorable temperature properties with regard to its use as heating steam for the intermediate superheater according to the invention.

The further intermediate superheater is advantageously arranged within a steam boiler. A further intermediate superheater of this type is consequently heated by the heating gas carried in the steam boiler.

Furthermore, the steam boiler may advantageously be heated by a fossil fuel or be designed as a waste-heat boiler which can be heated by exhaust gas from a gas turbine.

The first-mentioned embodiment includes actively heated steam boilers having burners to which fossil fuel is supplied.

The last-mentioned steam boiler does not include a boiler heated actively by burners and fuel, but a boiler to which already hot heating gas is supplied.

Particularly suitable for such purposes for heating a steam boiler is exhaust gas from a gas turbine, the exhaust gas having a temperature which is suitable for generating operating steam for a steam turbine in a waste-heat boiler.

Waste-heat boilers of this type can preferably be used in power stations which have at least one gas and one steam turbine, for example gas and steam power stations. In this case, the hot exhaust gas from the gas turbine is utilized for generating operating steam for the steam turbine, and often the additional active heating of the exhaust gas may be dispensed with.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

The figure is a block diagram of a steam turbine according to the invention

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The steam turbine 1 according to the invention has a high-pressure stage 3, a medium-pressure stage 5 and at least one low-pressure stage 7. For the generation of electrical energy, the steam turbine 1 is coupled to a generator 9 which may be located on the same shaft as the turbine stages.

To operate this steam turbine 1 according to the invention, fresh steam, which is preferably generated by a steam boiler 13, is supplied to the high-pressure stage 3 by a steam feed 11.

Normally, a priority of superheating stages, which are heated by a heating gas 22, are arranged in the steam boiler 13. The figure has dispensed with an illustration of these various superheater stages for the sake of greater clarity and has illustrated only those details which are important in connection with the invention.

A steam stream 20, which, after work has been performed in the high-pressure stage 3, leaves the latter, is super heated by a further intermediate superheater 15 arranged in the steam boiler 13 and is supplied to the medium-pressure stage 5.

The medium-pressure stage 5 is connected to the lower-pressure stage 7 by an overflow line 17. According to the invention, an intermediate superheater 14, which can be heated by steam, is connected into this overflow line 17. The heating steam required for this purpose is preferably extracted from the steam stream 20 which leaves a high-pressure stage 3. The heating steam for the intermediate superheater 14 is supplied to the intermediate superheater 14 by a heating-steam line 12. As illustrated by dots in the figure, the overflow line 17 may be lead further on from the low-pressure state 7 to a further low-pressure stage.

In a similar way to the steam turbine according to the invention, it is conceivable, in a modification of the invention, likewise to provide a steam-heated intermediate superheater in an overflow line between the low-pressure stage and a further low-pressure stage of the steam turbine. The heating steam for this purpose may be extracted, for example, from a steam stream which is supplied to one of the superheating stages arranged in the steam boiler, including the further intermediate superheater 15 illustrated. A suitable intermediate superheater is advantageously selected on the basis of the temperature range in which the respective further intermediate superheater operates.

Essential aspects of the invention can be summarized as follows:

In a steam turbine 1 according to the invention, a steam-heated intermediate superheater 14 is provided, which is connected into the overflow line 17 between the medium-pressure stage 5 and a low-pressure stage 7 of the steam turbine 1. The heating steam for the intermediate superheater 14 is in this case preferably extracted from what may be referred to as the cold first intermediate superheating.

An increase in efficiency of the steam turbine 1 can be achieved by the invention.

The invention has been described in detail with particular reference to preferred embodiments thereof and examples, but it will be understood that variations and modifications can be effected within the spirit and scope of the invention.

1. A steam turbine, comprising:
at least one high-pressure stage;
at least one medium-pressure stage;
at least one low-pressure stage;
at least one steam duct, arranged between said medium-pressure and low-pressure stages, to supply steam from said medium-pressure stage to said low-pressure stage,; and
at least one intermediate superheater connected into said at least one steam duct and heated by steam.

2. The steam turbine as claimed in claim 1,
wherein said at least one intermediate superheater includes a first intermediate superheater, and
wherein said steam turbine further comprises:
a second intermediate superheater; and
a supplementary steam duct supplying steam used to heat both said first and second intermediate superheaters.

3. The steam turbine as claimed in claim 2,
wherein said supplementary steam duct is connected to receive the steam which leaves said high-pressure stage, and
wherein said second intermediate superheater produces steam for said medium-pressure stage.

4. The steam turbine as claimed in claim 3, further comprising a steam boiler in which said second intermediate superheater is arranged.

5. The steam turbine as claimed in claim 4, wherein said steam boiler is heated by a fossil fuel.

6. The steam turbine as claimed in claim 4, wherein said steam boiler is coupled to receive exhaust gas from a gas turbine as a waste-heat boiler heated by the exhaust gas from the gas turbine.
